(19) United States
(12) Patent Application Publication
(10) Pub. No.: US 2015/0379795 A1
(43) Pub. Date: Dec. 31, 2015

(54) Active Detection Type Radio Frequency Identification Smart Door Lock Controller

(71) Applicant: MICROPROGRAM INFORMATION CO., LTD., Taichung City (TW)

(72) Inventor: Teng-Yen Wu, Taichung City (TW)

(21) Appl. No.: 14/598,283

(22) Filed: Jan. 16, 2015

(30) Foreign Application Priority Data
Jun. 30, 2014 (TW) 103211578

(51) Int. Cl. G07C 9/00

(52) U.S. Cl. CPC G07C 9/00309; G07C 2009/00317

(57) ABSTRACT

An active detection type radio frequency identification (RFID) smart door lock controller includes a door lock controller having a triggering unit with an infrared sensing module for transmitting an infrared signal. The door lock controller further includes a reading unit and a control unit operatively coupled to a door lock. A user information is stored in an electronic tag unit having an RFID module. The triggering unit is activated when the infrared signal is blocked by the electronic tag unit and actuates the reading unit to activate the RFID module by a first RFID signal. The user information is sent by the RFID module to the reading unit by a second RFID signal and is then sent to the control unit. The control unit compares the user information with a user information stored in the control unit to decide whether or not to unlock the door lock.

### BACKGROUND OF THE INVENTION

The present invention relates to an active detection type radio frequency identification smart door lock controller and, more particularly, to a door lock controller permitting an electronic tag to automatically transmit a command of opening a door lock according to setting of a household or commercial field domain.

Access management of personnel and/or vehicles becomes important due to complexity of large populations in modern cities and busy commercial and industrial activities. Human labor is used in conventional door access management to manage access of a building or a community, which is a waste of labor and is inefficient. Surveillance of an ordinary residential building is generally conducted by security guards at certain places only, which is not risk-proof in management. Burglary and/or injury risk of the residents due to human negligence occur from time to time.

More and more new modern smart buildings utilize electronic locks to control opening and closing of doors. Door access control systems for buildings are commonly used to enhance convenience and safety of the users. However, electronic locks used in door access control generally use single code verification, which is a radio frequency identification (RFID) type door access control.

A door access control device using an RFID tag generally includes at least one central processing unit, a memory unit connected to the central processing unit, at least one RFID reading unit connected to the central processing unit, a power supply connected to the central processing unit and the RFID reading unit, at least one transmission interface connected to the central processing unit, and at least one analog-controlled DIDO interface connected to the central processing unit. The RFID reading unit receives information of an electronic tag and sends the information to the central processing unit. The central processing unit conducts analysis and operation according to the received information and information stored in the memory unit and can proceed with data exchange with the outside via the transmission interface or can be connected to at least one controlled mechanism via the analog-controlled DIDO interface. An example of such a door access control device is disclosed in Taiwan Utility Model No. M464752.

U.S. patent application Ser. No. 14/571,409 (Taiwan Patent Application No. 103201403) by the Applicant discloses a door lock management control system includes a door controller including a reading module for reading a door opening message and a control module electrically connected to the reading module. The control module can receive signals from the reading module, control a door lock, and store access identification numbers. A main control unit includes a key tag and a near field communication (NFC) controllable device. One or both of the key tag and the NFC controllable device can be granted door lock management authority. The NFC controllable device can receive information from the control module via point-to-point transmission. At least one door opening unit sends a door opening message to the reading module and can be in the form of an NFC device. The NFC device can be granted door access authority by the key tag or the NFC controllable device.

Comparing the above conventional technique with the door lock management control system of Applicant, the central processing unit of the conventional technique has to conduct analysis and operation after the RFID reading unit receives the information of the electronic tag, and the result of operation has to be transmitted to another mechanism via a transmission interface or a DIDO interface, which is complicated in transmission control while failing to permit setting according to authority. Furthermore, the mobile electronic tag keeps sending signals to the RFID reading unit and, thus, consumes power rapidly. Furthermore, a double check mechanism is required to effectively solve the safety risk of door locks.

Thus, a need exits for an active detection type radio frequency identification smart door lock controller to provide enhanced utility.

### BRIEF SUMMARY OF THE INVENTION

The primary objective of the present invention is to provide an active detection type radio frequency identification smart door lock controller to solve the disadvantage of rapid power consumption of the door lock power source and the mobile electronic tag while providing a double check mechanism. The door lock controller according to the present invention permits an electronic tag to automatically transmit a command of opening a door lock according to setting of a household or commercial field domain.

In a first aspect, the present invention provides an active detection type radio frequency identification smart door lock controller including a door lock controller and an electronic tag unit. The door lock controller includes a triggering unit, a reading unit, and a control unit. The triggering unit includes an infrared sensing module is configured for transmitting an infrared signal. The control unit is configured to be operatively coupled to a door lock. The electronic tag unit includes a radio frequency identification module and is adapted to be carried by a user. A user information is stored in the electronic tag unit. The electronic tag unit is configured for conducting a short range induction with the triggering unit. The electronic tag unit is configured for blocking the infrared signal. The triggering unit is configured to be activated when the infrared signal is blocked by the electronic tag unit and is configured to actuate the reading unit to activate the radio frequency identification module of the electronic tag unit by a first radio frequency identification signal. The user information is adapted to be sent by the radio frequency identification module of the electronic tag unit to the reading unit by a second radio frequency identification signal and is then sent to the control unit. The control unit is configured to compare the user information with a user information stored in the control unit and configured to decide whether or not to unlock the door lock based on a result of comparison.

The door lock controller can further include a first button and a second button. When in a general mode, the first button provides an unlocking function, and the second button provides a locking function. When in a management mode, the first button provides an adding function of adding user information of a new user, and the second button provides a deleting function of deleting the user information of a selected user.

The door lock controller can further include an alarm device adapted to send an alarm.

The door lock controller further can further include a power backup device for supplying electricity to the door lock controller.

The first radio frequency identification signal sent by the reading unit can be a high frequency signal, and the second radio frequency identification signal sent by the electronic tag unit to the radio frequency identification module of the reading unit can be a high frequency signal.

The electronic tag unit can be a card, an object wearable on a wrist of the user, or a remote control.

In a second aspect, the present invention provides an active detection type radio frequency identification smart door lock controller including a door lock controller and an electronic tag unit. The door lock controller includes a triggering unit, a reading unit, and a control unit. The triggering unit includes an infrared sensing module. The infrared sensing module is configured for transmitting an infrared signal. The control unit is configured to be operatively coupled to a door lock. The electronic tag unit is adapted to be carried by a user. A user information is stored in the electronic tag unit. The electronic tag unit includes a received signal strength indication value that is set according to a field domain. The received signal strength indicator value is a distance range for awakening the electronic tag unit.

When the electronic tag unit is located in the distance range and is triggered by the triggering unit, the user information is sent from the electronic tag unit to the reading unit by a radio frequency identification signal and is then sent to the control unit, the control unit is configured to compare the user information with a user information stored in the control unit and configured to decide whether or not to unlock the door lock based on a result of comparison. The control unit unlocks the door lock only when it is identified that the user information contained in the radio frequency identification signal is identical to the user information of the control unit and when the user is within an infrared detection range of the infrared signal transmitted by the infrared sensing module.

The door lock controller can further include a first button and a second button. When in a general mode, the first button provides an unlocking function, and the second button provides a locking function. When in a management mode, the first button provides an adding function of adding user information of a new user, and the second button provides a deleting function of deleting the user information of a selected user.

The door lock controller can further include an alarm device adapted to send an alarm.

The door lock controller can further include an image pick-up device configured to provide a monitoring function.

The triggering unit of the door lock controller can send a low frequency radio frequency identification signal to activate the electronic tag unit. The radio frequency identification signal sent from the electronic tag unit to the reading unit of the door lock controller can be an ultrahigh frequency signal.

The electronic tag unit can be a card, an object wearable on a wrist of the user, a remote control, or any object carried by the user.

The triggering unit of the door lock controller can include a low frequency triggering module having the received signal strength indication value. The low frequency triggering module of the triggering unit of the door lock controller transmits a low frequency signal. The reading unit of the door lock controller can include an ultrahigh frequency radio frequency identification reading module. The electronic tag unit can include a low frequency triggering module, an ultrahigh frequency radio frequency identification module, and a battery. The battery provides electricity to the low frequency triggering module of the electronic tag unit and the ultrahigh frequency radio frequency identification module of the electronic tag unit. The low frequency triggering module of the electronic tag unit is triggered by the low frequency triggering module of the triggering unit of the door lock controller when the electronic tag unit is within the distance range. The ultrahigh frequency radio frequency identification module of the electronic tag unit is activated by the low frequency triggering module of the electronic tag unit to send an ultrahigh frequency radio frequency identification signal containing the user information of the electronic tag unit to the ultrahigh frequency radio frequency identification reading module of the reading unit of the door lock controller. The control unit compares the signal indicative of the user information with the user information of the control unit and unlocks the door lock if it is identified that the user information contained in the signal is the same as the user information of the control unit and when the user is within the infrared detection range of the infrared signal transmitted by the infrared sensing module.

The electronic tag unit can further include a high frequency radio frequency identification module. The reading unit of the door lock controller can further include a high frequency radio frequency identification reading module. When the battery is out of electricity, the high frequency reading module of the reading unit of the door lock controller sends a high frequency radio frequency identification signal to activate the high frequency radio frequency identification module of the electronic tag unit when the high frequency radio frequency identification reading module of the reading unit of the door lock controller is within an operation range of the high frequency radio frequency identification module of the electronic tag unit. The high frequency radio frequency identification module of the electronic tag unit sends the user information by a high frequency radio frequency identification signal to the high frequency radio frequency identification reading module of the reading unit of the door lock controller. The reading unit sends the signal to the control unit. The control unit compares the signal indicative of the user information with the user information of the control unit and unlocks the door lock if it is identified that the user information contained in the signal is the same as the user information of the control unit.

The infrared detection range of the infrared signal transmitted by the infrared sensing module of the triggering unit is smaller than the distance range for awakening the electronic tag unit.

The present invention will become clearer in light of the following detailed description of illustrative embodiments of this invention described in connection with the drawings.

### DESCRIPTION OF THE DRAWINGS

FIG. 1 is a diagrammatic view of an active detection type radio frequency identification smart door lock controller of the first embodiment according to the present invention for household use.

FIG. 2 is a schematic perspective view illustrating use of the active detection type radio frequency identification smart door lock controller of FIG. 1.

FIG. 3 is a diagrammatic view of an active detection type radio frequency identification smart door lock controller of a second embodiment according to the present invention for commercial use.

FIG. 4 is a schematic perspective view illustrating use of the active detection type radio frequency identification smart door lock controller of FIG. 3.

### DETAILED DESCRIPTION OF THE INVENTION

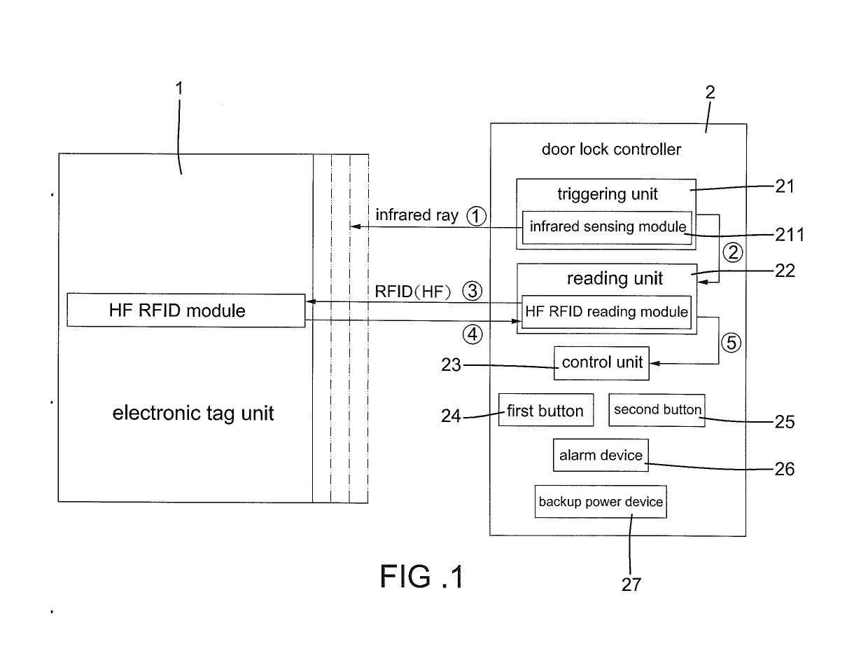

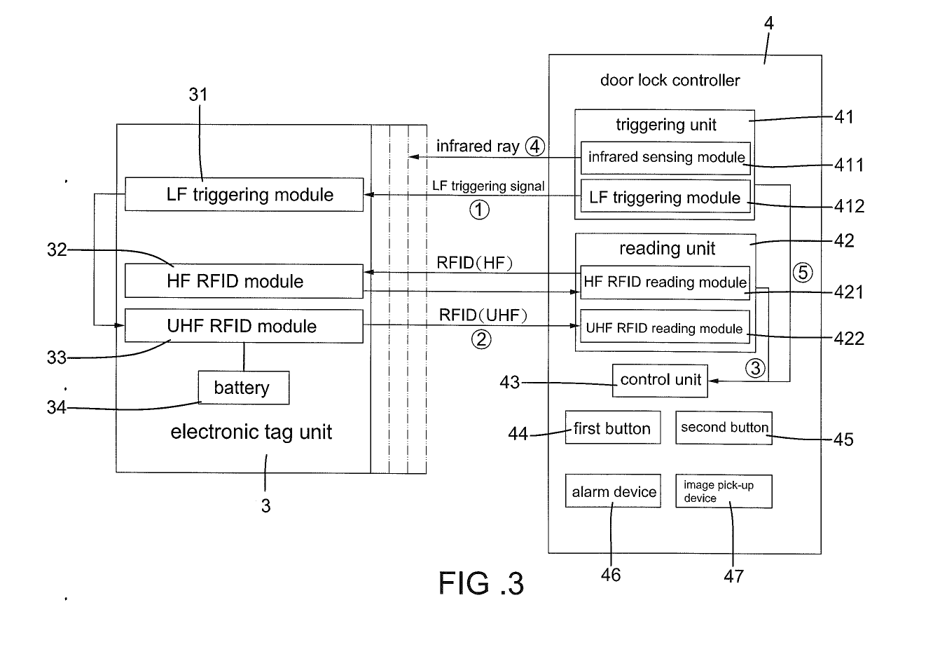

With reference to FIGS. 1-4, an active detection type radio frequency identification (RFID) smart door lock controller according to the present invention includes at least one electronic tag unit 1, 3 and a door lock controller 2, 4. The door lock controller 2, 4 includes a triggering unit 21, 41, a reading unit 22, 42, and a control unit 23, 43. The control unit 23, 43 is configured to be operatively coupled to a door lock. The active detection type RFID smart door lock controller of FIG. 1 is suitable for household use. The active detection type RFID smart door lock controller of FIG. 3 is suitable for commercial use.

In the first embodiment shown in FIG. 1, the door lock controller 2 is configured to be operatively coupled to a household door lock having a short detection range to avoid invasion by unauthorized persons. The electronic tag unit 1 includes a high frequency (HF) RFID module 12. The electronic tag unit 1 further includes a memory in which user information, such as an access identification number, is stored. The control unit 23 also includes the user information. The triggering unit 21 is configured to proceed with short range induction with the electronic tag unit 1. The triggering unit 21 includes an infrared sensing module 211 configured for transmitting an infrared signal. The electronic tag unit 1 is configured to block the infrared signal for activating the triggering unit 21 to actuate the reading unit 22. In this embodiment, the reading unit 22 includes a HF RFID reading module 221 that can read the user information of the electronic tag unit 1 by a high frequency (HF) radio frequency identification (RFID) signal. The HF RFID module 12 of the electronic tag unit 1 sends the user information to the infrared sensing module 211 of the reading unit 22 by a high frequency (HF) RFID signal. Then, the reading unit 22 sends the signal to the control unit 23. The control unit 23 compares the signal indicative of the user information with the user information of the control unit 23 and unlocks the door lock if it is identified that the user information contained in the signal is identical to the user information of the control unit 23.

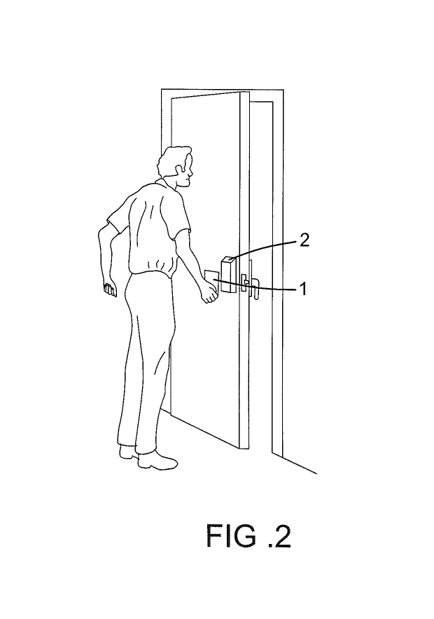

With reference to FIGS. 1 and 2, the sequence of operation of the active detection type RFID smart door lock controller of the first embodiment is indicated by the circled numbers in FIG. 1. In actual use of the active detection type RFID smart door lock controller of the first embodiment, a user carries the electronic tag unit 1 in which the user information (i.e., an access identification number) is stored. The electronic tag unit 1 can be a card, an object wearable on the wrist of the user, a remote control, or any object that can be carried by the user. When the user stands in front of the door lock controller 2 installed on the door of his home, the electronic tag unit 1 blocks the infrared signal emitted by the infrared sensing module 211. The triggering unit 21 is activated to actuate the reading unit 22, which, in turn, sends a HF RFID signal to activate the HF RFID module 12 of the electronic tag unit 1. The HF RFID module 12 of the electronic tag unit 1 sends the user information by a HF RFID signal to the reading unit 22, which, in turn, sends the signal to the control unit 23. The control unit 23 compares the signal indicative of the user information with the user information of the control unit 23 and unlocks the door lock if it is identified that the user information contained in the signal is the same as the user information of the control unit 23.

In a case that the door lock controller 2 is destructed or forcible intrusion occurs, the door lock controller 2 further includes an alarm device 26 for sending an alarm (such as sounding a siren) to warn the user. Furthermore, the door lock controller 2 includes a backup power device 27 (FIG. 1), such as a battery, to supply electricity for the whole door lock controller 2. Since the reading unit 22 and the control unit 23 of the door lock controller 2 are only actuated by the triggering unit 21, the disadvantage of rapid power consumption of the door lock controller 2 can be solved. Furthermore, the door lock controller 2 includes a first button 24 and a second button 25. The first button 24 and the second button 25 have different functions in different modes (a management mode and a general mode) of the door lock controller 2 set according to the authority of the electronic tag unit 1.

In the general mode, when the door lock controller 2 is destructed or malfunctions, the first button 24 provides an unlocking function, and the second button 25 provides a locking function, which can be appreciated by one skilled in the art. In the management mode, the first button 24 provides an adding function of adding a new manager or a new user, and the second button 25 provides a deleting function of deleting a manager or a user, which can be appreciated by one skilled in the art.

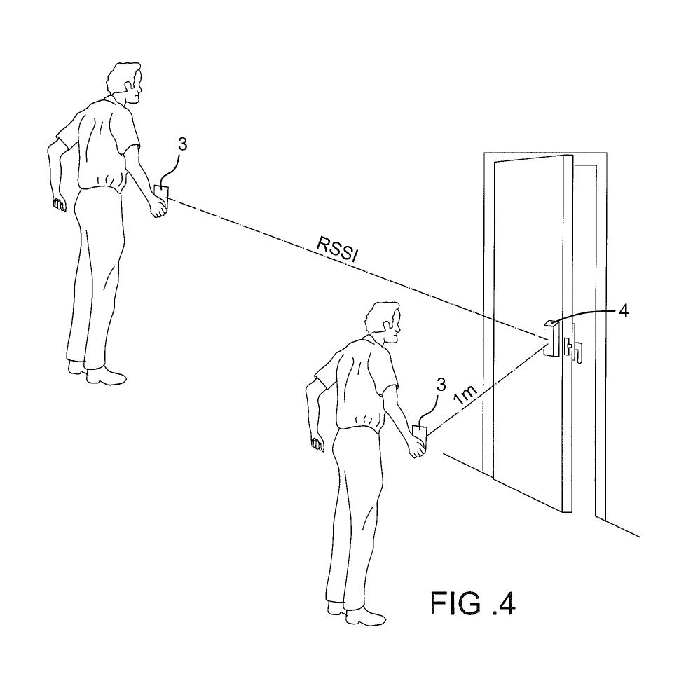

In the second embodiment shown in FIGS. 3 and 4, the door lock controller 4 is adapted to be operatively coupled to a commercial door lock. Since more people pass by, the security inspection must be enhanced as a measure of precaution. The active detection type RFID smart door lock controller includes at least one electronic tag unit 3 and the door lock controller 4. The door lock controller 4 includes the triggering unit 41, the reading unit 42, and the control unit 43, as mentioned above.

The electronic tag unit 3 includes a memory in which user information, such as an access identification number, is stored. The electronic tag unit 3 can be a card, an object wearable on the wrist of the user, a remote control, or any object that can be carried by the user. The electronic tag unit 3 includes a low frequency (LF) triggering module 31 (serving as a reception end), a high frequency (HF) RFID module 32, and an ultrahigh frequency (UHF) RFID module 33, and a battery 34. The battery 34 supplies power to the LF triggering module 31 and the UHF RFID module 33.

The reading unit 42 includes a high frequency (HF) RFID reading module 421 and an ultrahigh frequency (UHF) RFID reading module 422. The triggering unit 41 includes an infrared sensing module 411 and a low frequency (LF) triggering module 412 (which serves as a transmitting end). The trigger module 412 (the transmitting end) includes a received signal strength indicator (RSSI) value that is set according to the field domain. The RSSI value is a distance range for awakening the electronic tag unit 3. When the electronic tag unit 3 receives a triggering signal from the LF triggering module 412 (the transmitting end), the user information of the electronic tag unit 3 is sent from the UHF RFID module 33 by an ultrahigh frequency (UHF) RFID signal to the reading unit 42 and is then sent to the control unit 43 for comparison purposes. When the holder of the electronic tag unit 3 moves to a location within an infrared signal detection range of the infrared sensing module 411, the control unit 43 verifies the user information and the range and decides whether to unlock the door lock after verification.

With reference to FIGS. 3 and 4, the sequence of operation of the active detection type RFID smart door lock controller of the second embodiment is indicated by the circled numbers in FIG. 3. In actual use of the active detection type RFID smart door lock controller of the second embodiment, a plurality of electronic tag units 3 can be used, with each user carrying an electronic tag unit 3 in which the user information (i.e., an access identification number) is stored.

When in use, the LF triggering module 412 (the transmitting end) of the triggering unit 41 transmits a low frequency triggering signal. When any one of the electronic tag units 3 is within the distance range of the RSSI value in which the low frequency triggering signal can be received, the LF triggering module 31 (the reception end) of the electronic tag unit 3 is awakened, and the UHF RFID module 33 of the electronic tag unit 3 is activated to send the user information of the electronic tag unit 3 by an UHF RFID signal. After the reading unit 42 reads the user information, the user information is sent to the control unit 43. The control unit 43 compares the signal indicative of the user information with the user information of the control unit 43 and prepares to unlock the door lock if it is identified that the user information contained in the signal is the same as the user information of the control unit 43. During the procedure of reading and comparison of the user information, the user keeps moving towards the door lock. When the user reaches a location within an infrared signal transmitting range (such as 1 meter) of the infrared sensing module 411 of the triggering unit 4, the infrared sensing module 411 detects the presence of an object (the user in this case) within its infrared signal transmitting range (because the infrared sensor reading is changed), confirming that the user has reached the safe unlocking range. Thus, a double check (user information and distance) is made before the door lock is unlocked.

In a case that the battery 34 is out of electricity, the UHF RFID module 33 cannot transmit the UHF RFID signal to the UHF RFID reading module 422, such that the control unit 43 cannot verify the user information. In this case, when the user reaches a position close to the door lock controller 2 (the HF RFID reading module 421 of the reading unit 42 of the door lock controller 2 is within an operation range, such as 1 cm, of the HF RFID module 32 of the electronic tag unit 3), the HF RFID reading module 421 sends an HF RFID signal to activate the HF RFID module 32 of the electronic tag unit 3. The HF RFID module 32 of the electronic tag unit 3 sends the user information by an HF RFID signal to the reading unit 42, which, in turn, sends the signal to the control unit 43. The control unit 43 compares the signal indicative of the user information with the user information of the control unit 43 and unlocks the door lock if it is identified that the user information contained in the signal is the same as the user information of the control unit 43.

Furthermore, the door lock controller 4 for commercial use includes a first button 44 and a second button 45. The first button 44 and the second button 45 have different functions in different modes (a management mode and a general mode) of the door lock controller 4 set according to the authority of the electronic tag unit 3. In the general mode, when the door lock controller 4 is destructed or malfunctions, the first button 44 provides an unlocking function, and the second button 45 provides a locking function. In the management mode, the first button 44 provides an adding function of adding a new manager or a new user, and the second button 45 provides a deleting function of deleting a manager or a user. In a case that the door lock controller 4 is destructed or forcible intrusion occurs, the door lock controller 2 further includes an alarm device 46 for sending an alarm (such as sounding a siren) to warn the user.

Still referring to FIG. 3, the infrared sensing module 411 of the door lock controller 4 can detect movement of the object within the detection range, and the LF triggering module 412 of the door lock controller 4 can detect each electronic tag unit 3 within the RSSI range. Furthermore, the control unit 43 of the door lock controller 4 can record access of the users passing through the door. The door lock controller 4 can further include an image pick-up device 47 for monitoring the users carrying the electronic tag units 3. All of these provide complete functions of door access management.

Since the UHF RFID module of the electronic tag unit 3 begins to send the user information by the UHF RFID signal after triggering by the LF triggering module 412 (the transmitting end) of the door lock controller 4, the disadvantage of rapid power consumption of the electronic tag unit 3 can be solved.

Although specific embodiments have been illustrated and described, numerous modifications and variations are still possible without departing from the scope of the invention. The scope of the invention is limited by the accompanying claims.

1. An active detection type radio frequency identification smart door lock controller, comprising:
a door lock controller including a triggering unit, a reading unit, and a control unit, with the triggering unit including an infrared sensing module, with the infrared sensing module configured for transmitting an infrared signal, and with the control unit configured to be operatively coupled to a door lock; and
an electronic tag unit including a radio frequency identification module and adapted to be carried by a user, with a user information stored in the electronic tag unit, with the electronic tag unit configured for conducting a short range induction with the triggering unit, with the electronic tag unit configured for blocking the infrared signal, with the triggering unit configured to be activated when the infrared signal is blocked by the electronic tag unit and configured to actuate the reading unit to activate the radio frequency identification module of the electronic tag unit by a first radio frequency identification signal, with the user information adapted to be sent by the radio frequency identification module of the electronic tag unit to the reading unit by a second radio frequency identification signal and then sent to the control unit, and with the control unit configured to compare the user information with a user information stored in the control unit and configured to decide whether or not to unlock the door lock based on a result of comparison.

2. The active detection type radio frequency identification smart door lock controller as claimed in claim 1, with the door lock controller further including a first button and a second button,
wherein when in a general mode, the first button provides an unlocking function, and the second button provides a locking function, and
wherein when in a management mode, the first button provides an adding function of adding user information of a new user, and the second button provides a deleting function of deleting the user information of a selected user.

3. The active detection type radio frequency identification smart door lock controller as claimed in claim 2, with the door lock controller further including an alarm device, and with the alarm device adapted to send an alarm.

4. The active detection type radio frequency identification smart door lock controller as claimed in claim 1, wherein the door lock controller further includes a power backup device for supplying electricity to the door lock controller.

5. The active detection type radio frequency identification smart door lock controller as claimed in claim 1, wherein the first radio frequency identification signal sent by the reading unit is a high frequency signal, and wherein the second radio frequency identification signal sent by the electronic tag unit to the radio frequency identification module of the reading unit is a high frequency signal.

6. The active detection type radio frequency identification smart door lock controller as claimed in claim 1, wherein the electronic tag unit is a card, an object wearable on a wrist of the user, or a remote control.

7. The active detection type radio frequency identification smart door lock controller as claimed in claim 5, wherein the electronic tag unit is a card, an object wearable on a wrist of the user, or a remote control.

8. An active detection type radio frequency identification smart door lock controller, comprising:
a door lock controller including a triggering unit, a reading unit, and a control unit, with the triggering unit including an infrared sensing module, with the infrared sensing module configured for transmitting an infrared signal, and with the control unit configured to be operatively coupled to a door lock; and
an electronic tag unit adapted to be carried by a user, with a user information stored in the electronic tag unit, with the electronic tag unit including a received signal strength indication value that is set according to a field domain, with the received signal strength indicator value being a distance range for awakening the electronic tag unit,
wherein when the electronic tag unit is located in the distance range and is triggered by the triggering unit, the user information is sent from the electronic tag unit to the reading unit by a radio frequency identification signal and is then sent to the control unit, the control unit is configured to compare the user information with a user information stored in the control unit and configured to decide whether or not to unlock the door lock based on a result of comparison, and
wherein the control unit unlocks the door lock only when it is identified that the user information contained in the radio frequency identification signal is identical to the user information of the control unit and when the user is within an infrared detection range of the infrared signal transmitted by the infrared sensing module.

9. The active detection type radio frequency identification smart door lock controller as claimed in claim 8, with the door lock controller further including a first button and a second button,
wherein when in a general mode, the first button provides an unlocking function, and the second button provides a locking function, and
wherein when in a management mode, the first button provides an adding function of adding user information of a new user, and the second button provides a deleting function of deleting the user information of a selected user.

10. The active detection type radio frequency identification smart door lock controller as claimed in claim 9, with the door lock controller further including an alarm device, and with the alarm device adapted to send an alarm.

11. The active detection type radio frequency identification smart door lock controller as claimed in claim 10, wherein the door lock controller further includes an image pick-up device configured to provide a monitoring function.

12. The active detection type radio frequency identification smart door lock controller as claimed in claim 8, with the triggering unit of the door lock controller sending a low frequency radio frequency identification signal to activate the electronic tag unit, and with the radio frequency identification signal sent from the electronic tag unit to the reading unit of the door lock controller being an ultrahigh frequency signal.

13. The active detection type radio frequency identification smart door lock controller as claimed in claim 8, wherein the electronic tag unit is a card, an object wearable on a wrist of the user, or a remote control.

14. The active detection type radio frequency identification smart door lock controller as claimed in claim 8, with the triggering unit of the door lock controller including a low frequency triggering module having the received signal strength indication value, with the low frequency triggering module of the triggering unit of the door lock controller transmitting a low frequency signal, with the reading unit of the door lock controller including an ultrahigh frequency radio frequency identification reading module, with the electronic tag unit including a low frequency triggering module, an ultrahigh frequency radio frequency identification module, and a battery, with the battery providing electricity to the low frequency triggering module of the electronic tag unit and the ultrahigh frequency radio frequency identification module of the electronic tag unit, with the low frequency triggering module of the electronic tag unit being triggered by the low frequency triggering module of the triggering unit of the door lock controller when the electronic tag unit is within the distance range, with the ultrahigh frequency radio frequency identification module of the electronic tag unit activated by the low frequency triggering module of the electronic tag unit to send an ultrahigh frequency radio frequency identification signal containing the user information of the electronic tag unit to the ultrahigh frequency radio frequency identification reading module of the reading unit of the door lock controller, and with the control unit comparing the signal indicative of the user information with the user information of the control unit and unlocking the door lock if it is identified that the user information contained in the signal is the same as the user information of the control unit and when the user is within the infrared detection range of the infrared signal transmitted by the infrared sensing module.

15. The active detection type radio frequency identification smart door lock controller as claimed in claim 14, with the electronic tag unit further including a high frequency radio frequency identification module, with the reading unit of the door lock controller further including a high frequency radio frequency identification reading module,
wherein when the battery is out of electricity, the high frequency reading module of the reading unit of the door lock controller sends a high frequency radio frequency identification signal to activate the high frequency radio frequency identification module of the electronic tag unit when the high frequency radio frequency identification reading module of the reading unit of the door lock controller is within an operation range of the high frequency radio frequency identification module of the electronic tag unit, the high frequency radio frequency identification module of the electronic tag unit sends the user information by a high frequency radio frequency identification signal to the high frequency radio frequency identification reading module of the reading unit of the door lock controller, the reading unit sends the signal to the control unit, and the control unit compares the signal indicative of the user information with the user information of the control unit and unlocks the door lock if it is identified that the user information contained in the signal is the same as the user information of the control unit.

16. The active detection type radio frequency identification smart door lock controller as claimed in claim 14, wherein the infrared detection range of the infrared signal transmitted by the infrared sensing module of the triggering unit is smaller than the distance range for awakening the electronic tag unit.
